(19) United States
(12) Patent Application Publication
(10) Pub. No.: US 2022/0017678 A1
(43) Pub. Date: Jan. 20, 2022

(54) POLYURETHANE COMPOSITION RAW MATERIAL LIQUID AGENT, POLYURETHANE COMPOSITION, AND MIXING SYSTEM

(71) Applicant: SEKISUI CHEMICAL CO., LTD., Osaka (JP)

(72) Inventors: Shunji OHARA, Ageo-shi, Saitama (JP); Yuu KAKIMOTO, Kita-ku, Tokyo (JP); Tomonori KAJITA, Atsugi-shi, Kanagawa (JP); Akitsu HIRONO, Hasuda-shi, Saitama (JP)

(73) Assignee: SEKISUI CHEMICAL CO., LTD., Osaka (JP)

(21) Appl. No.: 17/299,614

(22) PCT Filed: Dec. 4, 2019
(86) PCT No.: PCT/JP2019/047465

§ 371 Date: Jun. 3, 2021

(30) Foreign Application Priority Data
Dec. 4, 2018 (JP) 2018-227360

(51) Int. Cl. C08G 18/32; C08K 3/02; B65D 83/68; B05C 17/005; B01F 5/04

(52) U.S. Cl. CPC C08G 18/3203; C08K 3/02; B65D 83/682; B01F 2215/0039; B01F 5/0406; C08K 2003/023; B05C 17/00553

(57) ABSTRACT

A polyurethane composition raw material liquid agent comprises a polyol or an isocyanate, and a filler. The polyurethane composition raw material liquid agent has a viscosity at 25° C. and a rotation speed of 60 rpm of 950 mPa·s or less, and is filled in at least one cartridge-like container of a caulking gun that includes two cartridge-like containers and is capable of mixing two components.

### TECHNICAL FIELD

The present invention relates to a polyurethane composition raw material liquid agent, a polyurethane composition, and a mixing system.

### BACKGROUND ART

Conventionally, a polyurethane foam has been used as a thermal insulator for vehicles such as automobiles, railroad carriages, and ships, as well as for buildings. As the polyurethane foam, a two-component polyurethane in which a polyol liquid agent and an isocyanate liquid agent filled in different containers are mixed to form a foam is widely used.

A caulking gun (sometimes referred to as a “spray gun”) is one simple two-component mixing and discharge device that mixes and discharges a polyol liquid agent and an isocyanate liquid agent. The caulking gun has a mechanism for separately filling liquid agents into two cartridges, extruding the contents by pushing a piston in each cartridge, and mixing the extruded contents at the rate at which the contents were discharged.

For example, in Patent Literature 1, a method in which a caulking gun that contains a main agent including a polyisocyanate compound or the like and a curing agent including a polyol or the like in two separate containers is used to mix and discharge the main agent and the curing agent at the tip of the caulking gun to fill a urethane resin composition into an opening of a building material or the like.

### CITATION LIST

### Patent Literature

PTL1: JP 2016-183259 A

### SUMMARY OF INVENTION

### Technical Problem

A caulking gun like that described above, which includes two cartridges and is capable of mixing two components, has an advantage in that it can be easily used on site. In recent years, due to heightened awareness of disaster prevention or the like, polyurethane foam used as a thermal insulator may be required to have high flame retardancy performance, and investigations are being carried out into using a flame retardant having a high flame retardancy effect as a filler. However, with the above-described caulking gun, such demands can be met.

Although the caulking gun has such an advantage, when the caulking gun is driven, there may be a lag in the discharge response to application of an external force to the piston. Specifically, discharge continues for a certain period of time and for a certain amount even when the application of the external force is released, so that a residual liquid may occur. If this excess residual liquid adheres to a discharge portion of the caulking gun or the like, not only does it take time and effort to remove the residual liquid, but the residual liquid may harden and cause problems such as clogging of the nozzle.

In particular, many flame retardants having a high flame retardancy effect are in a solid state, and when blended as a filler with a polyol, the fluidity of the polyol is reduced. That is, when the filler is added, viscosity increases, so that residual pressure tends to remain in the caulking gun, and particularly problems such as those described above tend to occur.

Therefore, an object of the present invention is to provide a polyurethane composition raw material liquid agent capable of suppressing, even when the raw material liquid agent contains a filler, a residual liquid amount produced after a caulking gun is used.

### Solution to Problem

The present inventors have investigated the mechanism in which a residual liquid occurs. As a result, the present inventors discovered that the occurrence of residual liquid is related to the magnitude of the external force and the viscosity of the liquid agent, and found that the above-described problems can be solved by reducing the viscosity of the liquid agent to a predetermined value or less.

That is, the present invention is as follows.
[1] A polyurethane composition raw material liquid agent, comprising a polyol or an isocyanate, and a filler,

the polyurethane composition raw material liquid agent having a viscosity at 25° C. and a rotation speed of 60 rpm of 950 mPa·s or less, and

the polyurethane composition raw material liquid agent is filled in at least one cartridge-like container of a caulking gun that includes two cartridge-like containers and is capable of mixing two components.
[2] The polyurethane composition raw material liquid agent according to [1], wherein the polyurethane composition raw material liquid agent has a solid content concentration ratio obtained by dividing a solid content concentration of a supernatant liquid left to stand for 20 hours at 25° C. by a solid content concentration of the liquid present below the supernatant liquid of 0.25 or more.
[3] The polyurethane composition raw material liquid agent according to [2], wherein the solid content concentration ratio is 0.4 or more.
[4] A polyurethane composition raw material liquid agent according to any one of [1] to [3], having a viscosity at 25° C. and a rotation speed of 60 rpm of 900 mPa·s or less.
[5] A polyurethane composition raw material liquid agent according to [4], having a viscosity at 25° C. and a rotation speed of 60 rpm of 850 mPa·s or less.
[6] A polyurethane composition raw material liquid agent according to any one of [1] to [5], comprising an anti-sedimentation agent.
[7] A polyurethane composition raw material liquid agent according to [6], comprising Si as an element constituting the anti-sedimentation agent.
[8] The polyurethane composition raw material liquid agent according to any one of [1] to [7], wherein the filler is at least one flame retardant selected from the group consisting of a red phosphorus flame retardant, a phosphoric acid salt-containing flame retardant, a bromine-containing flame retardant, a chlorine-containing flame retardant, an antimony-containing flame retardant, a boron-containing flame retardant, and a metal hydroxide.
[9] A polyurethane composition formed from a reaction product of the polyurethane composition raw material liquid agent according to any one of [1] to [8].
[10] The polyurethane composition according to [9], wherein the polyurethane composition is used as a thermal insulator for a vehicle or a building.
[11] A mixing system comprising:

a first cartridge-like container filled with the polyurethane composition raw material liquid agent according to any one of [1] to [8]; and

a second cartridge-like container filled with another polyurethane composition raw material liquid agent that reacts with the polyurethane composition raw material liquid agent to produce a polyurethane composition, wherein

the first and second cartridge-like containers are incorporated in a caulking gun capable of mixing two components, and

the polyurethane composition raw material liquid agent extruded from the first cartridge and the another polyurethane composition raw material liquid agent extruded from the second cartridge-like container are mixed by a discharge mechanism of the caulking gun.
[12] The mixing system according to [11], comprising a stationary mixer that mixes the polyurethane composition raw material liquid agent extruded from the first cartridge and the another polyurethane composition raw material liquid agent extruded from the second cartridge-like container.

### Advantageous Effects of Invention

According to the present invention, a polyurethane composition raw material liquid agent can be provided that is capable of suppressing, even when the raw material liquid agent contains a filler, a residual liquid amount produced after a caulking gun is used.

### BRIEF EXPLANATION OF DRAWING

FIG. 1 is a schematic view illustrating an embodiment of a mixing system of the present invention.

### DESCRIPTION OF EMBODIMENTS

The present invention will now be described in detail with reference to the following embodiments.

### [Polyurethane Composition Raw Material Liquid Agent]

The polyurethane composition raw material liquid agent of the present invention comprises a polyol or an isocyanate, and a filler. The polyurethane composition raw material liquid agent has a viscosity at 25° C. and a rotation speed of 60 rpm (hereinafter, sometimes referred to as “viscosity at 25° C. and 60 rpm”) of 950 mPa·s or less, and is filled in at least one cartridge-like container of a caulking gun that includes two cartridge-like containers and is capable of mixing two components.

In the present invention, the residual liquid amount can be suppressed by setting the viscosity at 25° C. and 60 rpm of the polyurethane composition raw material liquid agent to 950 mPa·s or less. Although it is not clear why the residual liquid amount can be suppressed by setting the viscosity at 25° C. and 60 rpm to 950 mPa·s or less, it is inferred that if the viscosity is not too high, stress relaxation in the polyurethane composition raw material liquid agent tends to rapidly progress, so that the stress due to external force is less likely to remain in the polyurethane composition raw material liquid agent, whereby the residual liquid amount is suppressed. On the other hand, when the viscosity at 25° C. and 60 rpm exceeds 950 mPa·s, the stress due to external force tends to remain in the polyurethane composition raw material liquid agent due to the high viscosity of the liquid agent. As a result, residual pressure is generated, and discharge continues for a certain period of time and for a certain amount even when application of the external force is released. From this viewpoint, the viscosity at 25° C. and 60 rpm is preferably 900 mPa·s or less, and more preferably 850 mPa·s or less.

Further, in a filler addition system, in general, the higher the viscosity of the polyurethane composition raw material liquid agent, the less likely filler sedimentation occurs. From this viewpoint, the viscosity at 25° C. and 60 rpm is preferably 400 mPa·s or more, more preferably 500 mPa·s or more, and further preferably 650 mPa·s or more.

In order to set the viscosity at 25° C. and 60 rpm to 950 mPa·s or less, for example, the filler content may be adjusted, or in the case of adding an anti-sedimentation agent, the amount of the anti-sedimentation agent may be adjusted. Further, for example, as a foaming agent or the like to be blended in the liquid agent, by selecting a foaming agent that has a high compatibility with the polyol or isocyanate to serve as the main component of the liquid agent, the viscosity can be decreased even when the number of parts added is the same. In addition, by selecting an additive that itself has a low viscosity, the viscosity of the overall liquid agent can be suppressed.

(Solid Content Concentration and Solid Content Concentration Ratio)

The polyurethane composition raw material liquid agent of the present invention preferably has a solid content concentration of 15 to 55% by mass. Here, the solid content is the component that remains by removing the polyurethane composition raw material liquid agent by filtering, and refers to the insoluble matter that is not dissolved in the polyurethane composition raw material liquid agent. Details of the method for measuring the solid content concentration are as described in the Examples.

By setting the solid content concentration to 15% by mass or more, a certain amount or more of the filler, such as a solid flame retardant component, is easily blended, and it is easier to improve the flame retardancy or the like of a polyurethane foam that is obtained. From the viewpoint of obtaining even better filler properties, such as flame retardancy, the solid content concentration is more preferably 17% by mass or more, and further preferably 20% by mass or more.

On the other hand, by setting the solid content concentration to 55% by mass or less, the polyurethane composition raw material liquid agent can be discharged at a high discharge flow rate, the miscibility between the two liquids is increased, and as a result the polyurethane foam has excellent various properties such as flame retardancy. From the viewpoint of improving the miscibility and further increasing the flame retardancy and the like, the solid content concentration is more preferably 40% by mass or less, and further preferably 35% by mass or less.

Further, a solid content concentration ratio obtained by dividing a solid content concentration of a supernatant liquid left to stand for 20 hours at 25° C. by a solid content concentration of the liquid present below the supernatant liquid is preferably 0.25 or more, and more preferably 0.4 or more.

The solid content concentration ratio indicates the degree of sedimentation, and the closer the ratio is to 1, the less sedimentation there is and the more the dispersion stability is maintained. When the solid content concentration ratio is 0.25 or more, the dispersion stability is good, and the solid content can be easily uniformly dispersed by re-stirring. It is noted that the upper limit is 1, at which the solid content concentration of the supernatant liquid and the solid content concentration of the liquid present below the supernatant liquid are the same.

The solid content concentration ratio can be determined by the method described in the Examples.

The polyurethane composition raw material liquid agent of the present invention comprises a polyol or isocyanate, and a filler, and further comprises an anti-sedimentation agent, a foam stabilizing agent, a trimerization catalyst, a resinification catalyst, a foaming agent, water, and the like as appropriate.

For example, an example of the polyurethane composition raw material liquid agent is a liquid agent including a polyol and a filler, as well as at least one further selected from the group consisting of an anti-sedimentation agent, a foam stabilizing agent, a trimerization catalyst, a resinification catalyst, a foaming agent, and water, and a liquid agent including an isocyanate and a filler, as well as at least one further selected from the group consisting of an anti-sedimentation agent, a foam stabilizing agent, and a foaming agent. Of these examples, a liquid agent including a polyol and a filler, as well as at least one further selected from the group consisting of an anti-sedimentation agent, a foam stabilizing agent, a trimerization catalyst, a resinification catalyst, a foaming agent, and water, is preferable, and a liquid agent including a polyol and a filler, as well as an anti-sedimentation agent, a foam stabilizing agent, a trimerization catalyst, a resinification catalyst, a foaming agent, and water is more preferable.

Hereinafter, each component used in the polyurethane composition raw material liquid agent of the present invention will be described in more detail.

(Polyol)

The polyurethane composition raw material liquid agent of the present invention comprises a polyol as a raw material of a polyurethane foam. Examples of the polyol include a polylactone polyol, a polycarbonate polyol, an aromatic polyol, an alicyclic polyol, an aliphatic polyol, a polyester polyol, a polymer polyol, a polyether polyol, and the like. The polyol is generally a liquid at normal temperature (23° C.) and normal pressure (1 atm).

Examples of the polylactone polyol include polypropiolactone glycol, polycaprolactone glycol, polyvalerolactone glycol, and the like.

Examples of the polycarbonate polyol include a polyol obtained by a dealcohol reaction between a hydroxyl group-containing compound, such as ethylene glycol, propylene glycol, butanediol, pentanediol, hexanediol, octanediol, and nonanediol, and ethylene carbonate, propylene carbonate, and the like.

Examples of the aromatic polyol include bisphenol A, bisphenol F, phenol novolac, cresol novolac, and the like.

Examples of the alicyclic polyol include cyclohexanediol, methylcyclohexanediol, isophoronediol, dicyclohexylmethanediol, dimethyldicyclohexylmethanediol, and the like.

Examples of the aliphatic polyol include alkanediol such as ethylene glycol, propylene glycol, butanediol, pentanediol, hexanediol, and the like.

Examples of the polyester polyol include a polymer obtained by dehydration condensation of a polybasic acid and a polyhydric alcohol, a polymer obtained by ring-opening polymerization of a lactone such as ε-caprolactone and α-methyl-ε-caprolactone, and a condensate of hydroxycarboxylic acid and the polyhydric alcohol or the like.

Examples of the polybasic acid include adipic acid, azelaic acid, sebacic acid, isophthalic acid (m-phthalic acid), terephthalic acid (p-phthalic acid), succinic acid, and the like. Further, examples of the polyhydric alcohol include bisphenol A, ethylene glycol, 1,2-propylene glycol, 1,4-butanediol, diethylene glycol, 1,6-hexane glycol, neopentyl glycol, and the like.

Examples of the hydroxycarboxylic acid include castor oil, a reaction product of castor oil and ethylene glycol, and the like.

Examples of the polymer polyol include a polymer obtained by graft-polymerizing an ethylenically unsaturated compound such as acrylonitrile, styrene, methyl acrylate, and methacrylate with an aromatic polyol, an alicyclic polyol, an aliphatic polyol, a polyester polyol, or the like, a polybutadiene polyol, a modified polyol of a polyhydric alcohol, a hydrogenated additive thereof, and the like.

Examples of the modified polyol of a polyhydric alcohol include a polyol modified by reacting the raw material polyhydric alcohol with an alkylene oxide, and the like.

Examples of the polyhydric alcohol include a trihydric alcohol such as glycerin and trimethylolpropane, tetra to octavalent alcohols such as pentaerythritol, sorbitol, mannitol, sorbitan, diglycerin, dipentaerythritol and the like, sucrose, glucose, mannose, fructose, methylglucoside, derivatives of these, and the like, polyols such as fluoroglucinol, cresol, pyrogallol, catechol, hydroquinone, bisphenol A, bisphenol F, bisphenol S, 1,3,6,8-tetrahydroxynaphthalene, and 1,4,5,8-tetrahydroxyanthracene, polyfunctional (for example, 2 to 100 functional groups) polyols such as castor oil polyol, a (co)polymer of hydroxyalkyl (meth)acrylate and a polyvinyl alcohol, a condensate of a phenol and formaldehyde (Novolak), and the like.

The method for modifying the polyhydric alcohol is not particularly limited, and a method for adding an alkylene oxide (hereinafter, also referred to as “AO”) can be preferably used. Examples of the AO include an AO having 2 to 6 carbon atoms, for example, ethylene oxide (hereinafter, also referred to as “EO”), 1,2-propylene oxide (hereinafter, also referred to as “PO”), 1,3-propylene oxide, 1,2-butylene oxide, 1,4-butylene oxide, and the like.

Among these, PO, from the viewpoint of properties and reactivity, PO, EO and 1,2-butylene oxide are preferable, and PO and EO are more preferable. When two or more kinds of AO are used (for example, PO and EO), the addition method may be block addition, random addition, or a combination of these.

Examples of the polyether polymer include a polymer obtained by subjecting at least one kind of alkylene oxide, such as ethylene oxide, propylene oxide, and tetrahydrofuran, to ring-opening polymerization in the presence of at least one kind of low-molecular-weight active hydrogen compound having two or more active hydrogens and the like. Examples of the low-molecular-weight active hydrogen compound having two or more active hydrogens include a diol such as bisphenol A, ethylene glycol, propylene glycol, butylene glycol, and 1,6-hexanediol, a triol such as glycerin and trimethylolpropane, an amine such as ethylenediamine and butylene diamine, and the like.

As the polyol used in the present invention, a polyester polyol and a polyether polyol are preferable. Among them, an aromatic polyester polyol obtained by dehydration condensation of a polybasic acid having an aromatic ring, such as isophthalic acid (m-phthalic acid) and terephthalic acid (p-phthalic acid), and a dihydric alcohol, such as bisphenol A, ethylene glycol, and 1,2-propylene glycol, is more preferable. Further, a polyol having two hydroxyl groups is preferable.

(Isocyanate)

As the polyisocyanate used as the isocyanate, a known polyisocyanate used for forming polyurethane foam can be used. Examples of the polyisocyanate include an aromatic polyisocyanate, an alicyclic polyisocyanate, an aliphatic polyisocyanate, and the like.

Examples of the aromatic polyisocyanate include phenylene diisocyanate, tolylene diisocyanate, xylylene diisocyanate, diphenylmethane diisocyanate, dimethyldiphenylmethane diisocyanate, triphenylmethane triisocyanate, naphthalene diisocyanate, polymethylene polyphenyl polyisocyanate (polymeric MDI), and the like.

Examples of the alicyclic polyisocyanate include cyclohexylene diisocyanate, methylcyclohexylene diisocyanate, isophorone diisocyanate, dicyclohexylmethane diisocyanate, dimethyldicyclohexylmethane diisocyanate, and the like.

Examples of the aliphatic polyisocyanate include methylene diisocyanate, ethylene diisocyanate, propylene diisocyanate, tetramethylene diisocyanate, hexamethylene diisocyanate, and the like.

Among these, from the viewpoint of ease of use and availability, an aromatic polyisocyanate is preferable, and diphenylmethane diisocyanate, polymeric MDI, or a mixture thereof is more preferable. One kind of polyisocyanate may be used alone, or two or more kinds may be mixed and used.

(Filler)

The filler preferably contains a flame retardant.

By using a flame retardant as a filler, high flame retardancy performance can be imparted to the polyurethane foam.

Further, examples of a filler other than a flame retardant that may be appropriately used include alumina, titanium oxide, calcium oxide, magnesium oxide, iron oxide, tin oxide, antimony oxide, a ferrite, basic magnesium carbonate, calcium carbonate, magnesium carbonate, zinc carbonate, barium carbonate, dosonite, hydrotalcite, calcium sulfate, barium sulfate, calcium silicate, talc, clay, mica, montmorillonite, bentonite, active white clay, imogolite, cericite, glass beads, silica balloon, aluminum nitride, boron nitride, silicon nitride, graphite, carbon balloon, charcoal powder, various metal powders, magnesium sulfate, lead zirconate titanate, molybdenum sulfide, silicon carbide, various magnetic powders, fly ash.

The filler is a solid component that is a solid at normal temperature and pressure. The filler may be used alone or in combination of two or more.

The flame retardant preferably used as a filler includes a solid flame retardant. In the present invention, flame retardancy can be more effectively increased by using a solid flame retardant. Further, usually, the solid flame retardant is in a dispersed state as a powder component in the polyurethane composition raw material liquid agent, and constitutes at least a part of the above-described solid content (insoluble matter).

The solid flame retardant is a flame retardant that is a solid at normal temperature (23° C.) and normal pressure (1 atm).

From the viewpoint of effectively increasing the flame retardancy, the solid flame retardant is preferably at least one selected from the group consisting of a red phosphorus flame retardant, a phosphoric acid salt-containing flame retardant, a bromine-containing flame retardant, a chlorine-containing flame retardant, an antimony-containing flame retardant, a boron-containing flame retardant, a metal hydroxide, and an acicular filler, and more preferably is at least one selected from the group consisting of a red phosphorus flame retardant, a phosphoric acid salt-containing flame retardant, a bromine-containing flame retardant, a chlorine-containing flame retardant, an antimony-containing flame retardant, a boron-containing flame retardant, and a metal hydroxide.

<Red Phosphorus Flame Retardant>

The red phosphorus flame retardant may be composed of red phosphorus alone, but may also be red phosphorus coated on a resin, a metal hydroxide, a metal oxide, or the like, or may be a mixture of red phosphorus with a resin, a metal hydroxide, a metal oxide or the like. The resin that may be coated with red phosphorus or mixed with red phosphorus is not particularly limited, and examples thereof include thermosetting resins such as a phenol resin, an epoxy resin, an unsaturated polyester resin, a melamine resin, a urea resin, an aniline resin, a silicone resin. As the compound to be coated or mixed, a metal hydroxide is preferable from the viewpoint of flame retardancy. The metal hydroxide may be appropriately selected and used from among those described later.

The amount of the red phosphorus flame retardant blended in the polyurethane composition raw material liquid agent is preferably 5 to 40 parts by mass, more preferably 12 to 35 parts by mass, and further preferably 15 to 32 parts by mass, and even further preferably 20 to 28 parts by mass, with respect to 100 parts by mass of the polyol or isocyanate. By setting the amount of the red phosphorus flame retardant blended to be not less than these lower limit values, the effect gained by containing the red phosphorus flame retardant is more easily exhibited. On the other hand, by setting the amount blended to be not more than these upper limit vales, foaming is not inhibited by the red phosphorus flame retardant.

<Phosphoric Acid Salt-Containing Flame Retardant>

Examples of the phosphoric acid salt-containing flame retardant include a phosphate composed of a salt with at least one metal or compound selected from various phosphoric acids, metals of Group IA to IVB of the Periodic Table, ammonia, an aliphatic amine, an aromatic amine, and a heterocyclic compound including nitrogen in the ring.

The phosphoric acid is not particularly limited, and examples thereof include a monophosphoric acid, a pyrophosphoric acid, a polyphosphoric acid.

Examples of the metals of Group IA to IVB of the Periodic Table include lithium, sodium, calcium, barium, iron(II), iron(III), and aluminum.

Examples of the aliphatic amine include methylamine, ethylamine, diethylamine, triethylamine, ethylenediamine, piperazine. Examples of the aromatic amine include aniline, o-toluidine, 2,4,6-trimethylaniline, anisidine, 3-trifluoromethyl) aniline. Examples of the heterocyclic compound containing nitrogen in the ring include pyridine, triazine, melamine.

Specific examples of the phosphoric acid salt-containing flame retardant include a monophosphate, a pyrophosphate, a polyphosphate. Here, the polyphosphate is not particularly limited, and examples thereof include ammonium polyphosphate, piperazine polyphosphate, melamine polyphosphate, ammonium amide polyphosphate, and aluminum polyphosphate.

One or more kinds of the above-described phosphoric acid salt-containing flame retardant can be used.

The amount of the phosphoric acid salt-containing flame retardant blended in the polyurethane composition raw material liquid agent is not particularly limited, and is 3 to 40 parts by mass, more preferably 5 to 35 parts by mass, and further preferably 10 to 30 parts by mass, with respect to 100 parts by mass of the polyol or isocyanate. By setting the amount of the phosphoric acid salt-containing flame retardant blended to be not less than these lower limit values, the effect gained by containing the phosphoric acid salt-containing flame retardant is exhibited more easily. On the other hand, by setting the amount blended to be not more than the upper limit values, foaming is not inhibited by the phosphoric acid salt-containing flame retardant.

<Bromine-Containing Flame Retardant>

The bromine-containing flame retardant is not particularly limited as long as it is a compound that contains bromine in its molecular structure and that is a solid at normal temperature and pressure. Examples thereof include a brominated aromatic ring-containing aromatic compound.

Examples of the brominated aromatic ring-containing aromatic compound include monomer-based organic bromine compounds such as hexabromobenzene, pentabromotoluene, hexabromobiphenyl, decabromobiphenyl, decabromodiphenyl ether, octabromodiphenyl ether, hexabromodiphenyl ether, bis(pentabromophenyDethane, ethylenebis(pentabromophenyl), ethylenebis(tetrabromophthalimide), tetrabromobisphenol A.

Further, the brominated aromatic ring-containing aromatic compound may be a bromine compound polymer. Specifically, examples include a polycarbonate oligomer produced from brominated bisphenol A as a raw material, a brominated polycarbonate of a copolymer and the like of this polycarbonate oligomer and bisphenol A, a diepoxy compound produced by a reaction between brominated bisphenol A and epichlorohydrin. Further examples include a brominated epoxy compound such as a monoepoxy compound obtained by a reaction between a brominated phenol and epichlorohydrin, poly(brominated benzyl acrylate), a condensate of a brominated polyphenylene ether, a brominated bisphenol A, and a brominated phenol of cyanur chloride, a brominated(polystyrene), a poly(brominated styrene), a brominated polystyrene such as a crosslinked brominated polystyrene, a crosslinked or non-crosslinked brominated poly(-methylstyrene).

Further, the bromine-containing flame retardant may be a compound other than a brominated aromatic ring-containing aromatic compound, such as hexabromocyclododecane.

These bromine-containing flame retardants may be used alone or in combination of two or more. Further, among the above, a brominated aromatic ring-containing aromatic compound is preferable, and among them, a monomer-based organic bromine compound such as ethylene bis(pentabromophenyl) is preferable.

The amount of the bromine-containing flame retardant blended in the polyurethane composition raw material liquid agent is preferably 3 to 45 parts by mass, more preferably 14 to 40 parts by mass, further preferably 18 to 38 parts by mass, and even further preferably 23 to 32 parts by mass, with respect to 100 parts by mass of the polyol or isocyanate. By setting the amount of the bromine-containing flame retardant blended to be not less than these lower limit values, the effect gained by containing the bromine-containing flame retardant is more easily exhibited. On the other hand, by setting the amount blended to be not more than these upper limit vales, foaming is not inhibited by the bromine-containing flame retardant flame retardant.

<Chlorine-Containing Flame Retardant>

Examples of the chlorine-containing flame retardant include those commonly used in flame retardancy resin compositions, such as polynaphthalene chloride, chlorendic acid, dodecachlorododecahydrodimethanodibenzocyclooctene sold under the trade name of “Dechlorane Plus”.

The blended amount of the chlorine-containing flame retardant used in the present invention is not particularly limited, and is preferably 3 to 40 parts by mass, more preferably 5 to 35 parts by mass, and further preferably 10 to 30 parts by mass, with respect to 100 parts by mass of the polyol or isocyanate. By setting the amount of the chlorine-containing flame retardant blended to be not less than these lower limit values, the effect gained by containing the chlorine-containing flame retardant is more easily exhibited. On the other hand, by setting the amount blended to be not more than these upper limit vales, foaming is not inhibited by the chlorine-containing flame retardant.

<Antimony-Containing Flame Retardant>

Examples of the antimony-containing flame retardant include an antimony oxide, an antimonate, a pyroantimonate. Examples of antimony oxide include antimony trioxide and antimony pentoxide. Examples of the antimonate include sodium antimonate, potassium antimonate. Examples of the pyroantimonate include sodium pyroantimonate, potassium pyroantimonate.

The antimony-containing flame retardant may be used alone or in combination of two or more. A antimony-containing flame retardant used in the present invention is preferably antimony trioxide.

The amount of the antimony-containing flame retardant blended in the polyurethane composition raw material liquid agent is not particularly limited, and is preferably 1 to 40 parts by mass, more preferably 2 to 35 parts by mass, and further preferably 3 to 30 parts by mass, with respect to 100 parts by mass of the polyol or isocyanate. By setting the amount of the antimony-containing flame retardant blended to be not less than these lower limit values, the effect gained by containing the antimony-containing flame retardant is more easily exhibited and flame retardancy is increased. On the other hand, by setting the amount blended to be not more than the upper limit vales, foaming is not inhibited by the antimony-containing flame retardant.

<Boron-Containing Flame Retardant>

Examples of the boron-containing flame retardant used in the present invention include borax, a boron oxide, boric acid, a borate. Examples of the boron oxide include diboron trioxide, boron trioxide, diboron dioxide, tetraboron trioxide, tetraboron pentoxide.

Examples of the borate include a borate of an alkali metal, an alkaline earth metal, an element of Groups 4, 12, and 13 of the Periodic Table, and ammonium. Specifically, examples include an alkali metal borate salt such as lithium borate, sodium borate, potassium borate, and cesium borate, an alkaline earth metal borate salt such as magnesium borate, calcium borate, and barium borate, zirconium borate, zinc borate, aluminum borate, and ammonium borate.

The boron-containing flame retardant may be used alone or in combination of two or more.

The boron-containing flame retardant used in the present invention is preferably a borate, and more preferably zinc borate.

The amount of the boron-containing flame retardant blended in the polyurethane composition raw material liquid agent is not particularly limited, and is preferably 1 to 40 parts by mass, more preferably 3 to 20 parts by mass, further preferably 5 to 15 parts by mass, and even further preferably 7 to 13 parts by mass, with respect to 100 parts by mass of the polyol or isocyanate. By setting the amount of the boron-containing flame retardant blended to be not less than these lower limit values, the effect gained by containing the boron-containing flame retardant is more easily exhibited and flame retardancy is increased. On the other hand, by setting the amount blended to be not more than these upper limit vales, foaming is not inhibited by the boron-containing flame retardant.

<Metal Hydroxide>

Examples of the metal hydroxide used in the present invention include magnesium hydroxide, calcium hydroxide, aluminum hydroxide, iron hydroxide, nickel hydroxide, zirconium hydroxide, titanium hydroxide, zinc hydroxide, copper hydroxide, vanadium hydroxide, tin hydroxide. The metal hydroxide may be used alone or in combination of two or more.

The amount of the metal hydroxide blended in the polyurethane composition raw material liquid agent is, for example, 0.1 to 50 parts by mass, preferably 0.2 to 30 parts by mass, more preferably 0.3 to 20 parts by mass, and further preferably 0.5 to 15 parts by mass, with respect to 100 parts by mass of the polyol or isocyanate. By setting the amount of the metal hydroxide blended to be not less than these lower limit values, the effect gained by containing the metal hydroxide is more easily exhibited and flame retardancy is increased. On the other hand, by setting the amount blended to be not more than these upper limit vales, foaming is not inhibited by the metal hydroxide.

<Acicular Filler>

Examples of the acicular filler used in the present invention include potassium titanate whisker, aluminum borate whisker, magnesium-containing whisker, silicon-containing whisker, wollastonite, sepiolite, zonolite, ellestadite, boehmite, rod-shaped hydroxyapatite, glass fiber, carbon fiber, graphite fiber, metal fiber, slag fiber, gypsum fiber, silica fiber, alumina fiber, silica alumina fiber, zirconia fiber, boron nitride fiber, boron fiber, stainless steel fiber.

One or more of these acicular fillers can be used.

The acicular filler used in the present invention has an aspect ratio (length/diameter) that is preferably in a range of 5 to 50, and more preferably in a range of 10 to 40. The aspect ratio can be determined by observing the acicular filler with a scanning electron microscope and measuring the length and width.

The amount of the acicular filler blended in the polyurethane composition raw material liquid agent is, for example, 3 to 30 parts by mass, preferably 3 to 20 parts by mass, more preferably 3 to 18 parts by mass, and further preferably 6 to 18 parts by mass, with respect to 100 parts by mass of the polyol or isocyanate. By setting the amount of the acicular filler blended to be not less than the lower limit values, the shape of the polyurethane composition after combustion can be easily maintained. On the other hand, by setting the amount blended to be not more than the upper limit values, foaming of the polyurethane composition is less likely to be inhibited.

<Amount of Solid Flame Retardant Blended>

In the present invention, the amount of the solid flame retardant blended in the polyurethane composition raw material liquid agent is set to be not more than a certain amount, and the solid content concentration, the viscosity, or both, of the polyurethane composition raw material liquid agent are set to within the desired ranges. As a result, the polyurethane composition raw material liquid agent can be discharged at a high discharge flow rate, and the miscibility with the another polyurethane composition raw material liquid agent for producing the polyurethane composition is also improved. From such a viewpoint, the amount of the solid flame retardant blended in the polyurethane composition raw material liquid agent may be, for example, 150 parts by mass or less with respect to 100 parts by mass of the polyol or isocyanate, but from the viewpoint of sufficiently increasing the discharge flow rate and also obtaining excellent miscibility, the amount blended is preferably 90 parts by mass or less, more preferably 85 parts by mass or less, and further preferably 75 parts by mass or less.

On the other hand, by setting the amount of the solid flame retardant blended in the polyurethane composition raw material liquid agent to be not less than a certain amount, the solid flame retardant can impart an appropriate flame retardancy to the polyurethane foam. From such a viewpoint, the amount of the solid flame retardant blended is, for example, 20 parts by mass or more with respect to 100 parts by mass of the polyol or isocyanate. However, in order to sufficiently increase the flame retardancy by the solid flame retardant, the amount blended is preferably 30 parts by mass or more, more preferably 45 parts by mass or more, further preferably 55 parts by mass or more, and most preferably 60 parts by mass or more.

(Liquid Flame Retardant)

The flame retardant contained in the polyurethane composition raw material liquid agent preferably contains a liquid flame retardant in addition to the above-described solid flame retardant. The liquid flame retardant is a flame retardant that is a liquid at normal temperature and pressure. Specific examples of the liquid flame retardant include a phosphoric acid ester. By containing a liquid flame retardant in the polyurethane composition raw material liquid agent, it is easier to improve the flame retardancy of the polyurethane composition raw material liquid agent with almost no reduction in the discharge flow rate, miscibility, and the like.

As the phosphoric acid ester, a monophosphoric acid ester, a condensed phosphoric acid ester, and the like can be used. The monophosphoric acid ester is a phosphoric acid ester having one phosphorus atom in the molecule. The monophosphoric acid ester is not particularly limited as long as it is a liquid at normal temperature and pressure, and examples include a trialkyl phosphate such as trimethyl phosphate, triethyl phosphate, tributyl phosphate, and tri(2-ethylhexyl) phosphate, a halogen-containing phosphoric acid ester such as tris(β-chloropropyl) phosphate, a trialkoxy phosphate such as tributoxyethyl phosphate, an aromatic ring-containing phosphoric acid ester such as tricresyl phosphate, trixylenyl phosphate, tris(isopropylphenyl) phosphate, cresyldiphenyl phosphate, and diphenyl(2-ethylhexyl) phosphate, an acidic phosphoric acid ester such as monoisodecyl phosphate and diisodecyl phosphate.

Examples of the condensed phosphoric acid ester include an aromatic condensed phosphoric acid ester such as trialkylpolyphosphate, resorcinol polyphenyl phosphate, bisphenol A polycredyl phosphate, and bisphenol A polyphenyl phosphate.

Examples of commercially available condensed phosphoric acid esters include “CR-733S”, “CR-741”, and “CR747”, which are manufactured by Daihachi Chemical Industry Co., Ltd., “Adeka Stub PFR” and “FP-600” manufactured by ADEKA.

As the liquid flame retardant, one kind of the above-described liquid flame retardants may be used alone, or two or more thereof may be used in combination. Among these, a monophosphoric acid ester is preferable, and a halogen-containing phosphoric acid ester such as tris(β-chloropropyl) phosphate is more preferable, from the viewpoint of facilitating an appropriate viscosity and improving the flame retardancy of the polyurethane foam.

When the polyurethane composition raw material liquid agent contains a liquid flame retardant, the amount of the liquid flame retardant blended in the polyurethane composition raw material liquid agent is preferably 5 to 70 parts by mass, more preferably 10 to 60 parts by mass, and further preferably 20 to 50 parts by mass, with respect to 100 parts by mass of the polyol or isocyanate. By setting the amount of the liquid flame retardant blended to be not less than these lower limit values, the effect gained by containing the liquid flame retardant is more easily exhibited. On the other hand, by setting the amount blended to be not more than these upper limit vales, foaming of the polyurethane foam is not inhibited by the liquid flame retardant.

Among the above-described solid flame retardants, it is preferable to use a red phosphorus flame retardant, a bromine-containing flame retardant, and a boron-containing flame retardant, and among them, it is preferable to use a red phosphorus flame retardant. By using a red phosphorus flame retardant, it is easier to further improve the flame retardancy.

Further, as the solid flame retardant, it is also preferable to use a red phosphorus flame retardant in combination with a solid flame retardant other than the red phosphorus flame retardant. In this case, the solid flame retardant other than the red phosphorus flame retardant may be one or more selected from the phosphoric acid salt-containing flame retardant, the bromine-containing flame retardant, the chlorine-containing flame retardant, the antimony-containing flame retardant, the boron-containing flame retardant, and the metal hydroxide, but it is preferably one or more selected from the bromine-containing flame retardant and the boron-containing flame retardant. By using the red phosphorus flame retardant in combination with the bromine-containing flame retardant or boron-containing flame retardant, it is even easier to further improve the flame retardancy.

In addition, from the viewpoint of flame retardancy, the solid flame retardant used in combination with the red phosphorus flame retardant is more preferably both the bromine-containing flame retardant and the boron-containing flame retardant.

Moreover, in the present invention, as described above, it is also preferable to use the solid flame retardant in combination with the liquid flame retardant. Therefore, as the flame retardant, it is preferable to use at least the red phosphorus flame retardant, which is a solid flame retardant, and the phosphoric acid ester, which is a liquid flame retardant.

From the viewpoint of flame retardancy, in addition to the red phosphorus flame retardant and the phosphoric acid ester, it is preferable to further use one or more selected from the phosphoric acid salt-containing flame retardant, the bromine-containing flame retardant, the chlorine-containing flame retardant, the antimony-containing flame retardant, the boron-containing flame retardant, and the metal hydroxide, and it is more preferable to further use one or more selected from the bromine-containing flame retardant and the boron-containing flame retardant.

Further, it is most preferable to use both the bromine-containing flame retardant and the boron-containing flame retardant in addition to the red phosphorus flame retardant and the phosphoric acid ester.

(Anti-Sedimentation Agent)

The polyurethane composition raw material liquid agent of the present invention preferably contains an anti-sedimentation agent. By using an anti-sedimentation agent, sedimentation of the filler dispersed in the polyurethane composition raw material liquid agent can be prevented. Further, by using an anti-sedimentation agent, it is easier to uniformly disperse the filler. The anti-sedimentation agent is generally a solid at normal temperature and pressure, and is usually solid content (insoluble matter) in the polyurethane composition raw material liquid agent.

The anti-sedimentation agent is not particularly limited, and preferably comprises, for example, Si as an element constituting the anti-sedimentation agent, and other than that, it is preferable to use one or more selected from carbon black, hydrogenated castor oil wax, fatty acid amide wax, organic clay, and the like. Among these, an anti-sedimentation agent including Si as an element constituting the anti-sedimentation agent is preferable, and a powdered silica is more preferable.

The carbon black used in the anti-sedimentation agent can be produced by a method such as a furnace method, a channel method, or a thermal method. A commercially available product may also be appropriately selected and used for the carbon black.

As the powdered silica, fumed silica, colloidal silica, silica gel, and the like can be used. Among these, fumed silica is preferable, and hydrophobic fumed silica is particularly preferable. As the fumed silica, Aerosil (registered trademark) manufactured by Nippon Aerosil Co., Ltd., can be used.

The hydrogenated castor oil wax, fatty acid amide wax, and the like form a swollen gel structure in a liquid. These are generally commercially available under names such as a thixotropic agent, a thickening agent, an anti-sedimentation agent, an anti-dripping agent, and commercially available products can be appropriately selected and used.

The amount of the anti-sedimentation agent blended is not particularly limited, and is, for example, 0.5 to 20 parts by mass, preferably 0.7 to 12 parts by mass, and more preferably 1.1 to 8 parts by mass, with respect to 100 parts by mass of the filler. By setting the amount of the anti-sedimentation agent blended to be within the above-described range, sedimentation of the filler can be prevented and the dispersibility of the filler can be improved without increasing the solid content more than necessary.

The polyurethane composition raw material liquid agent of the present invention preferably comprises a foaming agent. Examples of the foaming agent contained in the polyurethane composition raw material liquid agent include, but are not particularly limited to, a hydrofluoroolefin.

Examples of the hydrofluoroolefin include fluoroalkenes having 3 to 6 carbon atoms. Further, the hydrofluoroolefin may be a hydrochlorofluoroolefin having a chlorine atom, and therefore may be a chlorofluoroalkene or the like having 3 to 6 carbon atoms. The hydrofluoroolefin preferably has 3 or 4 carbon atoms, and further preferably has 3 carbon atoms.

More specifically, examples include trifluoropropene, a tetrafluoropropene such as HFO-1234, a pentafluoropropene such as HFO-1225, a chlorotrifluoropropene such as HFO-1233, chlorodifluoropropene, chlorotrifluoropropene, chlorotetrafluoropropene. More specifically, examples include 1,3,3,3-tetrafluoropropene (HFO-1234ze), 1,1,3,3-tetrafluoropropene, 1,2,3,3,3-pentafluoropropene (HFO-1225ye), 1,1,1-trifluoropropene, 1,1,1,3,3-pentafluoropropene (HFO-1225zc), 1,1,1,3,3,3-hexafluorobut-2-ene, 1,1,2,3,3-pentafluoropropene (HFO-1225yc), 1,1,1,2,3-pentafluoropropene (HFO-1225yz), 1-chloro-3,3,3-trifluoropropene (HFO-1233zd), 1,1,1,4,4,4-hexafluorobut-2-ene, 1,1,1,4,4,4-hexafluoro-2-butene (HFO-1336mzz). Of these, HFO-1233zd and HFO-1336mzz are preferable.

These hydrofluoroolefins may be used alone or in combination of two or more.

The hydrofluoroolefin may be used in combination with one or more selected from a hydrocarbon and dimethyl ether.

The amount of the foaming agent blended in the polyurethane composition raw material liquid agent is not particularly limited, and is preferably 10 to 150 parts by mass, more preferably 15 to 70 parts by mass, and further preferably 20 to 50 parts by mass, with respect to 100 parts by mass of the polyol or isocyanate. By setting the amount of the foaming agent blended to be within these ranges, it is easier to improve the discharge flow rate and the foaming property. Further, by setting the amount blended to be not more than the upper limit values, it is possible to prevent the foaming agent from being blended more than necessary.

(Foam Stabilizing Agent)

The polyurethane composition raw material liquid agent of the present invention preferably contains a foam stabilizing agent. The foam stabilizing agent improves the foaming property of the polyurethane composition obtained from the polyurethane composition raw material liquid agent and another polyurethane composition raw material liquid agent.

Examples of the foam stabilizing agent include a surfactant such as a polyoxyalkylene-based foam stabilizing agent, for example a polyoxyalkylene alkyl ether, a silicone-based foam stabilizing agent, for example an organopolysiloxane. These foam stabilizing agents may be used alone or in combination of two or more.

The amount of the foam stabilizing agent blended is preferably 0.1 to 10 parts by mass, more preferably 0.5 to 8 parts by mass, and further preferably 1 to 5 parts by mass, with respect to 100 parts by mass of the polyol or isocyanate. When the amount of the foam stabilizing agent blended is equal to or more than these lower limit values, the polyurethane composition, which is a reaction product of the polyurethane composition raw material liquid agent and the another polyurethane composition raw material liquid agent, can be easily foamed, and a homogeneous polyurethane foam can be easily obtained. Further, when the amount of the foam stabilizing agent blended is equal to or less than these upper limit values, the balance between the production cost and the obtained effect is good.

(Catalyst)

The polyurethane composition raw material liquid agent of the present invention preferably comprises a catalyst. The polyurethane composition raw material liquid agent of the present invention may comprise as the catalyst, for example, a trimerization catalyst, a resinification catalyst, or both, but it is preferable to contain both. These catalysts are included when a polyol is used in the polyurethane composition raw material liquid agent of the present invention.

The trimerization catalyst is a catalyst that promotes the formation of an isocyanurate rings by causing the isocyanate groups included in the polyisocyanate to react and trimerize. Examples of trimerization catalysts that can be used include a nitrogen-containing aromatic compound such as tris(dimethylaminomethyl)phenol, 2,4-bis(dimethylaminomethyl)phenol, and 2,4,6-tris(dialkylaminoalkyl)hexahydro-S-triazine, a carboxylic acid alkali metal salt such as potassium acetate, potassium 2-ethylhexanoate, and potassium octylate, a tertiary ammonium salt such as a trimethylammonium salt, a triethylammonium salt, and a triphenylammonium salt, a quaternary ammonium salt such as a tetramethylammonium salt, a tetraethylammonium salt, a tetraphenylammonium salt, and a triethylmonomethylammonium salt. Examples of the ammonium salt include an ammonium salt of a carboxylic acid such as 2,2-dimethylpropanoic acid, and more specifically a quaternary ammonium salt of a carboxylic acid.

These may be used alone or in combination of two or more.

Among these, one or more selected from a carboxylic acid alkali metal salt and a carboxylic acid quaternary ammonium salt are preferable, and a mode in which both of them are used is also preferable.

The amount of the trimerization catalyst blended is preferably 1 to 25 parts by mass, more preferably 2 to 18 parts by mass, and further preferably 3 to 15 parts by mass, with respect to 100 parts by mass of the polyol. When the amount of the trimerization catalyst blended is equal to or more than these lower limit values, trimerization of polyisocyanate occurs more easily, and the flame retardancy of the obtained polyurethane foam is improved. On the other hand, when the amount of the trimerization catalyst blended is equal to or less than these upper limit values, the reaction is controlled more easily.

The resinification catalyst catalyzes is a catalyst that promotes the reaction between the polyol and the polyisocyanate. Examples of the resinification catalyst include an amine-based catalyst such as an imidazole compound and a piperazine compound, a metal-based catalyst.

Examples of the imidazole compound include a tertiary amine in which the secondary amine at the 1-position of the imidazole ring is replaced with an alkyl group, an alkenyl group, or the like. Specific examples include N-methylimidazole, 1,2-dimethylimidazole, 1-ethyl-2-methylimidazole, 1-methyl-2-ethylimidazole, 1,2-diethylimidazole, and 1-isobutyl-2-methylimidazole. Further, an imidazole compound in which the secondary amine in the imidazole ring is replaced with a cyanoethyl group may be used.

In addition, examples of the piperazine compound include a tertiary amine such as N-methyl-N′N′-dimethylaminoethylpiperazine and trimethylaminoethylpip erazine.

Further, in addition to the imidazole compound and the piperazine compound, examples of the resinification catalyst include various tertiary amines such as pentamethyldiethylenetriamine, triethylamine, N-methylmorpholinbis(2-dimethylaminoethyl)ether, N,N,N′,N″,N″-pentamethyldiethylenetriamine, N,N,N′-trimethylaminoethyl-ethanolamine, bis(2-dimethylaminoethyDether, N,N-dimethylcyclohexylamine, diazabicycloundecene, triethylenediamine, tetramethylhexamethylenediamine, tripropylamine.

Examples of the metal-based catalyst include a metal salt composed of lead, tin, bismuth, copper, zinc, cobalt, nickel, and the like, and preferably an organic acid metal salt composed of lead, tin, bismuth, copper, zinc, cobalt, nickel and the like. More preferably, examples include dibutyltin dilaurate, dioctyltin dilaurate, dioctyltin versatate, bismuth trioctate, bismuth tris(2-ethylhexanoate), tin dioctylate, lead dioctylate, and the like. Among them, an organic acid bismuth salt is more preferable.

The resinification catalyst may be used alone or in combination of two or more. Further, among the above, it is preferable to use one or more selected from the imidazole compound and the organic acid bismuth salt, and a mode in which both of them are used is also preferable.

The amount of the resinification catalyst blended is preferably 1 to 25 parts by mass, more preferably 2 to 18 parts by mass, and even more preferably 3 to 12 parts by mass, with respect to 100 parts by mass of the polyol. When the amount of the resinification catalyst blended is equal to or more than these lower limit values, a urethane bond tends to form, and the reaction proceeds rapidly. On the other hand, when the amount blended is equal to or less than these upper limit values, the reaction rate is controlled more easily.

The total amount of the catalyst in the polyurethane composition raw material liquid agent is not particularly limited, and is preferably 2 to 40 parts by mass, more preferably 4 to 25 parts by mass, and further preferably 5 to 20 parts by mass. When the total amount is equal to or more than these lower limit values, the formation of urethane bonds and the trimerization proceed appropriately, and the flame retardancy tends to be good. Further, when the total amount is equal to or less than these upper limit values, the urethanization and trimerization reactions are controlled more easily.

(Water)

The polyurethane composition raw material liquid agent of the present invention may comprise water. The inclusion of water improves the foaming property when forming the polyurethane foam. Water is included when a polyol is used in the polyurethane composition raw material liquid agent of the present invention.

The amount of water blended is, for example, 0.1 to 10 parts by mass, preferably 0.2 to 5 parts by mass, and more preferably 0.3 to 3 parts by mass, with respect to 100 parts by mass of the polyol. By setting the amount of water blended to within these ranges, the polyurethane composition can be easily foamed appropriately.

(Other Components)

The polyurethane composition raw material liquid agent of the present invention may comprise, as long as the effect of the present invention is not impaired, components other than components described above.

For example, an additive such as a phenol-based, amine-based, sulfur-based or other antioxidant, a heat stabilizer, a metal damage inhibitor, an antistatic agent, a stabilizer, a cross-linking agent, a lubricant, a softener, a pigment, and a tackifying resin, and a tackifier such as polybutene and a petroleum resin, may be included.

However, in the polyurethane composition raw material liquid agent of the present invention, it is desirable not to blend more solid components that are solid at normal temperature and pressure than necessary. It is preferable to reduce the amount of the solid components blended other than the above-described components as much as possible, and the amount blended should be less than the total amount of the solid flame retardant and the anti-sedimentation agent blended. The amount of the solid content of the components blended other than the above-described components (that is, the polyol, isocyanate, filler, foam stabilizing agent, catalyst, flame retardant, anti-sedimentation agent, water, and foaming agent) is, for example, 10 parts by mass or less, preferably 5 parts by mass or less, and more preferably 1 part by mass or less, with respect to 100 parts by mass of the polyol or isocyanate.

(Method for Producing Polyurethane Composition Raw Material Liquid Agent)

The method for producing the polyurethane composition raw material liquid agent of the present invention is not particularly limited. For example, each component other than the foaming agent is mixed as necessary using a disper or the like, the foaming agent is then added, the mixture is stirred, the volatile substances are removed, and the fact that the specified amounts are included in the liquid agent is confirmed. Next, the liquid agent may be produced by being filled into a container such as a cartridge, and the container is sealed.

[Polyurethane Composition]

The polyurethane composition of the present invention is formed from a reaction product of the above-described polyurethane composition raw material liquid agent. That is, when the polyurethane composition raw material liquid agent includes a polyol, the polyurethane composition of the present invention is formed by reacting with another polyurethane composition raw material liquid agent including an isocyanate, and when the polyurethane composition raw material liquid agent includes an isocyanate, the polyurethane composition of the present invention is formed by reacting with another polyurethane composition raw material liquid agent including a polyol. At this time, the polyurethane composition raw material liquid agent, polyol liquid agent, and the another polyurethane composition raw material liquid agents to be reacted with the polyurethane composition raw material liquid agent may be mixed in a mass ratio such that the isocyanate index falls within a predetermined range as described later.

Further, the polyurethane composition is formed while foaming with the foaming agent contained in the polyurethane composition raw material liquid agent or a foaming agent contained in the another polyurethane composition raw material liquid agent to be reacted with the polyurethane composition raw material liquid agent, to thereby produce a polyurethane foam.

<Isocyanate Index>

The isocyanate index of the polyurethane composition of the present invention preferably 250 or more. When the isocyanate index is equal to or more than 250, the amount of polyisocyanate with respect to the polyol is in excess, so that isocyanurate bonds due to a polyisocyanate trimer tend to form, and as a result the flame retardancy of the polyurethane foam is improved. In order to further improve the flame retardancy, the isocyanate index is more preferably 300 or more, and further preferably 340 or more.

Further, the isocyanate index is preferably 1000 or less, more preferably 650 or less, and even further preferably 500 or less. When the isocyanate index is equal to or less than these upper limit values, the balance between the flame retardancy of the obtained polyurethane foam and the production cost is good.

[Method for Using Polyurethane Composition Raw Material Liquid Agent]

The polyurethane composition raw material liquid agent of the present invention is used, for example, for a caulking gun, and is used by filling at least one cartridge-like container of a caulking gun that includes two cartridge-like containers and is capable of mixing two components.

Here, the two cartridge-like containers may be formed such that during production of the polyurethane composition raw material liquid agent of the present invention, when filling the container and/or during storage, the polyurethane composition raw material liquid agent is separated from the another polyurethane composition raw material liquid agent, and the polyurethane composition raw material liquid agents are brought together from each container at the time of use, or may be formed such that the two cartridges are integrated from the start.

It is noted that the “another polyurethane composition raw material liquid agent” is a term that includes cases where the liquid agent is the polyurethane composition raw material liquid agent of the present invention and cases where it is not.

The capacity of each of the two cartridge containers may be the same or different. Further, the shape may be the same or different from each other.

The two cartridges may be arranged horizontally with respect to the discharge direction, or may be connected vertically (for example, in a coaxial direction).

Further, each cartridge may be made of a plastic such as polyethylene or polypropylene, and be a rigid cartridge having a shape such as a columnar shape, a prismatic columnar shape, or a semicircular columnar shape, or be a flexible cartridge having a pouch shape or the like.

When the cartridge is made of a rigid material, one of the surfaces of the cartridge can be formed into a piston shape, and the liquid agent in the cartridge can be discharged by applying an external force to that surface.

In the case of a pouch shape, the liquid agent in the pouch can be discharged by squashing the pouch with an external force. Further, to properly squash the pouch-shaped cartridge, it is preferable to provide guides made of a rigid material around the pouch during use.

A container used for a caulking gun may be used as the cartridge-like container for enclosing the polyurethane composition raw material liquid agent. That is, the present invention also provides a caulking gun that includes a cartridge-like container in which a polyurethane composition raw material liquid agent is enclosed.

For example, the caulking gun is a caulking gun capable of mixing two components that includes two cartridge-like containers. The polyurethane composition raw material liquid agent of the present invention is enclosed in at least one of the cartridge-like containers. As a result, since the polyurethane composition raw material liquid agent of the present invention and another polyurethane composition raw material liquid agent, which have been extruded separately, are mixed in a mixing section, for example, and the occurrence of residual liquid is suppressed during discharge from the mixing section from the caulking gun, clogging of the nozzle by cured residual liquid can be prevented.

(Mixing System)

The present invention also provides a mixing system for mixing a polyurethane composition raw material liquid agent and another polyurethane composition raw material liquid agent.

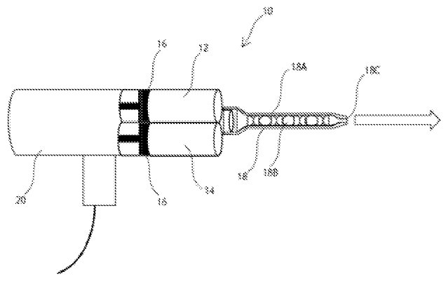

As illustrated in FIG. 1, a mixing system 10 includes a first cartridge-like container 12 filled with the polyurethane composition raw material liquid agent of the present invention, and a second cartridge-like container 14 filled with another polyurethane composition raw material liquid agent that reacts with the polyurethane composition raw material liquid agent of the present invention to produce a polyurethane composition. The first and second cartridge-like containers 12 and 14 are incorporated in a caulking gun capable of mixing two components. The polyurethane composition raw material liquid agent extruded from the first cartridge and the another polyurethane composition raw material liquid agent, which are extruded from the second cartridge-like container by a discharge mechanism of the caulking gun 20, for example, a piston 16 driven manually or by gas pressure, are mixed.

The mixing is carried out by driving the piston 16 manually or by an external force such gas pressure to extrude the polyurethane composition raw material liquid agent in each of the first and second cartridge-like containers 12 and 14, and the polyurethane composition raw material liquid agents are mixed in the mixing section where they meet. Examples of the extrusion driving force include manually driving or gas pressure using a cylinder or a compressor. For example, when a gas cylinder or compressor is used as the driving force, the driving force can be controlled by using a regulator of the gas cylinder or compressor. Generally, the secondary pressure is 0.05 to 0.8 MPa, and if the polyurethane composition raw material liquid agent of the present invention has a liquid agent viscosity adjusted corresponding to this external force, the amount of residual liquid can be suppressed.

The mixing section is a place where the polyurethane composition raw material liquid agent extruded from the first cartridge and the another polyurethane composition raw material liquid agent extruded from the second cartridge-like container are mixed, and is preferably a stationary mixer 18 called a so-called static mixer.

The stationary mixer 18 does not have a drive unit, and mixes fluids by passing the fluids through the inside of a pipe. Examples of the stationary mixer 18 include a mixer in which a mixer element 18B is arranged inside a pipe 18A as illustrated in FIG. 1. The mixer element 18B may be, for example, formed in a spiral shape or may be formed from a plurality of baffle plates.

The stationary mixer 18 may also include a function of an injector. In that case, as illustrated in FIG. 1, the mixture mixed inside the pipe 18A may be sprayed from a tip 18C of the pipe.

In the present invention, the polyurethane composition can be used for various applications, but it is preferably used as a thermal insulator. Since the polyurethane composition constitutes a polyurethane foam, it has a large number of cells, and therefore has a thermal insulating effect.

In particular, it is more preferable to use the polyurethane composition as a thermal insulator for a vehicle or a building. The term vehicle includes rail carriages, automobiles, ships, aircraft, and the like. The polyurethane composition of the present invention has a high flame retardancy due to using the polyurethane composition raw material liquid agent described above. Therefore, from the viewpoint of disaster prevention and safety, the polyurethane composition of the present invention can be suitably used for vehicle or building applications.

A polyurethane foam can be formed with a simple structure by using the polyurethane composition raw material liquid agent in a caulking gun that includes two cartridge-like containers and is capable of mixing two components as described above. The polyurethane composition raw material liquid agent of the present invention uses a caulking gun, and is therefore particularly suitable when the surface to be processed is relatively small. Therefore, for example, it is preferable to use the polyurethane composition raw material liquid agent of the present invention for a repair application in which a repair is performed by spraying the polyurethane composition raw material liquid agent onto a portion where an existing heat-resistant material has deteriorated or been damaged. Of course, the present invention is not limited to such applications, and the polyurethane composition raw material liquid agent of the present invention may be used for forming a new heat-resistant material.

### EXAMPLE

The present invention will now be described below in more detail with reference to examples, but the present invention is not limited thereto.

The methods for measuring the physical properties of the polyurethane composition raw material liquid agent are as follows.

### [Viscosity]

300 ml of the polyurethane composition raw material liquid agent was placed in a 300 ml polypropylene cup, and the value 1 minute after measuring the viscosity of the polyurethane composition raw material liquid agent at 60 rpm and 25° C. and using a B-type viscometer was recorded.

[Solid Content Concentration]

The weight of the polyurethane composition raw material liquid agent and the weight of a filter paper (Circular quantitative filter paper No. 3, manufactured by Advantech) were measured. The weight of the filter paper was taken as W0, and the total weight of the polyurethane composition raw material liquid agent and the filter paper was taken as W1. The polyurethane composition raw material liquid agent was suction filtered using the filter paper. The residue on the filter paper was washed several times with acetone, and then the filter paper and the residue were allowed to dry for 30 minutes in suction-filtered state. The total weight of the dried filter paper and residue was weighed, and the value was taken as W2. The solid content concentration (% by mass) was calculated by {(W1−W2)/(W1−W0)}×100.

[Sedimentation Property (Solid Content Concentration Ratio)]

400 ml of the polyurethane composition raw material liquid agent was placed in a 500 ml polypropylene cup and allowed to stand for 20 hours at 25° C. About 50 g of a supernatant liquid at a position within 2 cm from the liquid surface was collected from the solution after it had been left to stand for 20 hours, and the suction filtration was performed using a circular quantitative filter paper (No. 3) manufactured by Advantech. The solid matter on the filter paper was washed 3 to 5 times with acetone and dried under a draft for 16 hours. The weight of the filter paper at the time of drying was taken as W1, the amount of collected liquid was taken as W2, the weight of the solid matter including the weight of the filter paper after filtration/washing/drying was taken as W3, and the supernatant solid content weight W (top)=[(W3−W1)/W2]×100.

Further, from the solution that had been left to stand for 20 hours, the polyurethane composition raw material liquid agent was removed so as to leave the remaining 50 ml from the bottom, about 50 g was collected from the bottom 50 ml, and the solid content concentration was measured in the same manner as for the supernatant liquid. This value was taken as W (bottom).

The solid content concentration ratio was determined by calculating the solid content difference, that is, W (top)/W (bottom), from the two types of solid content concentrations obtained above. The sedimentation property was evaluated from this solid content concentration ratio.

[Residual Liquid Amount]

130 g of the polyurethane composition raw material liquid agent was filled into the filling point of each of the two cartridges of a two-component cartridge (manufactured by Ritter, product name: 16351-0002), and the two-component cartridge was mounted to a caulking gun (manufactured by SULZER, product name: DP-200-70-01). Further, using a 7 m³ compressed nitrogen gas cylinder (regulator, manufactured by Yamato Sangyo Co., Ltd., YR-70) to drive the caulking gun, the secondary working pressure of the gas cylinder was adjusted to 0.2 MPa. A static mixer (manufactured by Ritter, product name: 13300-2001) having a diameter of 8 mm and 18 elements was attached to the cartridge, and the liquid was discharged. After discharging about 65 g from each cartridge, for a total of about 130 g, the finger was released from the trigger of the caulking gun, and the weight of the solution discharged from the mixer was further measured from that point. A residual liquid amount was deemed to have occurred when 0.5 times the weight had overflowed from one filling point.

The components used in the examples and comparative examples are as follows. It is also noted that for the components that were diluted, the number of blended parts of each component shown in Table 1 indicates the number of blended parts of each component as the diluted component.
Polyol: Ester-based polyol compound (manufactured by Kawasaki Kasei Chemicals, product name: Maximol RLK-087, hydroxyl value=200 mgKOH/g)
Foam stabilizing agent: Polyoxyalkylene-based foam stabilizing agent (manufactured by Dow Corning Toray, product name SH-193)
Trimerization catalyst 1: Carboxylic acid quaternary ammonium salt (active ingredient amount 45 to 55% by mass, diluted with ethylene glycol) (Evonik Japan Co., Ltd., product name: DABCO TMR-7)
Trimerization catalyst 2: Potassium carboxylate (active ingredient approximately 75%, diluted with ethanediol, manufactured by Evonik Japan Co., Ltd., product name: DABCO K⁻15)
Resinification catalyst 1: Carboxylic acid bismuth salt (active ingredient 55 to 58%, diluted with 2-ethylhexanoic acid, manufactured by Nitto Kasei Co., Ltd., product name: Neostann U-600)
Resinification catalyst 2: Imidazole compound (active ingredient amount 65 to 75% by mass, diluted with ethylene glycol, manufactured by Tosoh Corporation, product name: TOYOCAT-DM70)
Liquid flame retardant: Tris((3-chloropropyl) phosphate (manufactured by Daihachi Chemical Co., Ltd., product name: TMCPP)
Solid flame retardant 1: Red phosphorus flame retardant (manufactured by Rin kagaku Kogyo Co., Ltd., product name: Nova Excel 140, metal hydroxide coating, red phosphorus content 94% by mass or more)
Solid flame retardant 2: Red phosphorus flame retardant (manufactured by Rin Kagaku Kogyo Co., Ltd., product name: Nova Red 120UFA, metal hydroxide coating, red phosphorus content 90% by mass or more)
Solid flame retardant 3: Zinc borate (manufactured by Hayakawa & Co., Ltd., product name: Firebrake ZB)
Solid flame retardant 4: Ethylene bis(pentabromophenyl) (manufactured by Albemarle, product name: SAYTEX 8010)
Anti-sedimentation agent: Fumed silica (manufactured by Aerosil Japan, product name: Aerosil R9765)
Foaming agent 1: HFO-1233zd (E) (manufactured by Central Glass Co., Ltd., product name: Solstice LBA)
Foaming agent 2: HFO-1336mzz (Z) (manufactured by Chemours-Mitsui Fluoroproducts Co., Ltd., product name: Opteon 1100)
Isocyanate: Polyisocyanate (MDI, manufactured by Sumitomo Chemical Co., Ltd., product name: Sumijuru 44V20)

### Example 1

In accordance with the blend shown in Table 1, the components other than the foaming agent were measured into a 1000 ml polypropylene beaker, mixed at 1500 rpm for 5 minutes using a disper, then the foaming agent was added, and mixing was further carried out to finally adjust so that the amount of the foaming agent remaining in the solution was as shown in Table 1 to obtain a polyurethane composition raw material liquid agent.

After measuring the viscosity of the obtained liquid agent, a part of the mixture was used for measuring the solid content concentration and the solid content concentration ratio, and a part was used for evaluating the residual liquid amount.

Table 1 shows the amount of each component based on 100 parts of polyol, the viscosity of the solution, the sedimentation property evaluation value, and the residual liquid amount.

### Example 2

A polyurethane composition raw material liquid agent was obtained in the same manner as in Example 1, except that the amount of the anti-sedimentation agent and of the foaming agent 2 were changed.

### Example 3

A polyurethane composition raw material liquid agent was obtained in the same manner as in Example 1, except that the amount of the anti-sedimentation agent was changed.

### Example 4

A polyurethane composition raw material liquid agent was obtained in the same manner as in Example 1, except that the amount of the anti-sedimentation agent and of the foaming agent 2 were changed.

### Example 5

A polyurethane composition raw material liquid agent was obtained in the same manner as in Example 1, except that the amount of the anti-sedimentation agent was changed.

### Example 6

A polyurethane composition raw material liquid agent was obtained in the same manner as in Example 1, except that the amount of the anti-sedimentation agent and of the foaming agent 2 were changed.

### Example 7

A polyurethane composition raw material liquid agent was obtained in the same manner as in Example 1, except that the amount of the anti-sedimentation agent was changed and the foaming agent 1 was used instead of the foaming agent 2.

### Example 8

In accordance with the blend shown in Table 1, the components other than the foaming agent were measured into a 1000 ml polypropylene beaker, mixed at 1500 rpm for 5 minutes using a disper, then the foaming agent was added, and mixing was further carried out to finally adjust so that the amount of the foaming agent remaining in the solution was as shown in Table 1 to obtain a polyurethane composition raw material liquid agent.

### Comparative Example 1

A polyurethane composition raw material liquid agent was obtained in the same manner as in Example 7, except that the amount of the anti-sedimentation agent was changed.

### Comparative Example 2

A polyurethane composition raw material liquid agent was obtained in the same manner as in Example 1, except that the amount of the anti-sedimentation agent was changed.

TABLE 1

| | | Example | Example | Example | Example | Example | Example |
|---|---|---|---|---|---|---|---|
| | | 1 | 2 | 3 | 4 | 5 | 6 |
| Mixed | Polyol | 100 | 100 | 100 | 100 | 100 | 100 |
| liquid | Foam | 2.6 | 2.6 | 2.6 | 2.6 | 2.6 | 2.6 |
| agent | stabilizing agent | | | | | | |
| blend | Trimerization | 7.8 | 7.8 | 7.8 | 7.8 | 7.8 | 7.8 |
| (parts by | catalyst 1 | | | | | | |
| mass) | Trimerization | 2.6 | 2.6 | 2.6 | 2.6 | 2.6 | 2.6 |
| | catalyst 2 | | | | | | |
| | Resinification | 2.6 | 2.6 | 2.6 | 2.6 | 2.6 | 2.6 |
| | catalyst 1 | | | | | | |
| | Resinification | 5.2 | 5.2 | 5.2 | 5.2 | 5.2 | 5.2 |
| | catalyst 2 | | | | | | |
| | Water | 0.7 | 0.7 | 0.7 | 0.7 | 0.7 | 0.7 |
| | Liquid flame | 39.1 | 39.1 | 39.1 | 39.1 | 39.1 | 39.1 |
| | retardant | | | | | | |
| | Solid flame | 26.1 | 26.1 | 26.1 | 26.1 | 26.1 | 26.1 |
| | retardant 1 | | | | | | |
| | Solid flame | 0.0 | 0.0 | 0.0 | 0.0 | 0.0 | 0.0 |
| | retardant 2 | | | | | | |
| | Solid flame | 9.8 | 9.8 | 9.8 | 9.8 | 9.8 | 9.8 |
| | retardant 3 | | | | | | |
| | Solid flame | 29.3 | 29.3 | 29.3 | 29.3 | 29.3 | 29.3 |
| | retardant 4 | | | | | | |
| | Anti- | 2.9 | 1.6 | 2.3 | 1.0 | 0.0 | 1.6 |
| | sedimentation | | | | | | |
| | agent | | | | | | |
| | Foaming agent 1 | 0.0 | 0.0 | 0.0 | 0.0 | 0.0 | 0.0 |
| | Foaming agent 2 | 27.4 | 23.5 | 27.4 | 23.5 | 23.5 | 23.5 |
| | Isocyanate | 0.0 | 0.0 | 0.0 | 0.0 | 0.0 | 0.0 |
| Mixed | Solid content | 26.6% | 26.6% | 26.4% | 26.4% | 26.1% | 26.6% |
| liquid | concentration (% | | | | | | |
| agent | by mass) | | | | | | |
| physical | Viscosity | 947 | 804 | 868 | 506 | 440 | 650 |
| properties | (mPa · s) | | | | | | |
| Flame | Sedimentation | 0.91 | 0.85 | 0.9 | 0.25 | 0.15 | 0.52 |
| retardancy | Residual liquid | 3.8 | 2.9 | 3.4 | 1.2 | 0.6 | 1.4 |
| evaluation | amount | | | | | | |

| | | Example | Example | Comparative | Comparative |
|---|---|---|---|---|---|
| | | 7 | 8 | Example 1 | Example 2 |
| Mixed | Polyol | 100 | 0 | 100 | 100 |
| liquid | Foam | 2.6 | 2.6 | 2.6 | 2.6 |
| agent | stabilizing agent | | | | |
| blend | Trimerization | 7.8 | 0.0 | 7.8 | 7.8 |
| (parts by | catalyst 1 | | | | |
| mass) | Trimerization | 2.6 | 0.0 | 2.6 | 2.6 |
| | catalyst 2 | | | | |
| | Resinification | 2.6 | 0.0 | 2.6 | 2.6 |
| | catalyst 1 | | | | |
| | Resinification | 5.2 | 0.0 | 5.2 | 5.2 |
| | catalyst 2 | | | | |
| | Water | 0.7 | 0.0 | 0.7 | 0.7 |
| | Liquid flame | 39.1 | 39.1 | 39.1 | 39.1 |
| | retardant | | | | |
| | Solid flame | 26.1 | 26.1 | 26.1 | 26.1 |
| | retardant 1 | | | | |
| | Solid flame | 0.0 | 0.0 | 0.0 | 0.0 |
| | retardant 2 | | | | |
| | Solid flame | 9.8 | 9.8 | 9.8 | 9.8 |
| | retardant 3 | | | | |
| | Solid flame | 29.3 | 29.3 | 29.3 | 29.3 |
| | retardant 4 | | | | |
| | Anti- | 3.4 | 2.6 | 4.9 | 3.6 |
| | sedimentation | | | | |
| | agent | | | | |
| | Foaming agent 1 | 39.1 | 0.0 | 39.1 | 0.0 |
| | Foaming agent 2 | 0.0 | 27.4 | 0.0 | 27.4 |
| | Isocyanate | 0.0 | 100.0 | 0.0 | 0.0 |
| Mixed | Solid content | 25.6% | 49.5% | 26.0% | 26.8% |
| liquid | concentration (% | | | | |
| agent | by mass) | | | | |
| physical | Viscosity | 718 | 898 | 1350 | 1700 |
| properties | (mPa · s) | | | | |
| Flame | Sedimentation | 0.75 | 0.89 | 0.91 | 0.94 |
| retardancy | Residual liquid | 2.2 | 3.1 | 13 | 18 |
| evaluation | amount | | | | |

As shown in the above examples, the residual liquid amount was suppressed in all the examples using the polyurethane composition raw material liquid agent having a viscosity of 950 mPa·s or less at 25° C. and a rotation speed of 60 rpm.

### REFERENCE SIGNS LIST

12 first cartridge-like container
14 second cartridge-like container
20 caulking gun
16 piston
18 stationary mixer
18A pipe
18B mixer element
18C tip

1. A polyurethane composition raw material liquid agent, comprising a polyol or an isocyanate, and a filler,
the polyurethane composition raw material liquid agent having a viscosity at 25° C. and a rotation speed of 60 rpm of 950 mPa·s or less, and
the polyurethane composition raw material liquid agent is filled in at least one cartridge-like container of a caulking gun that includes two cartridge-like containers and is capable of mixing two components.

2. The polyurethane composition raw material liquid agent according to claim 1, wherein the polyurethane composition raw material liquid agent has a solid content concentration ratio obtained by dividing a solid content concentration of a supernatant liquid left to stand for 20 hours at 25° C. by a solid content concentration of the liquid present below the supernatant liquid of 0.25 or more.

3. The polyurethane composition raw material liquid agent according to claim 2, wherein the solid content concentration ratio is 0.4 or more.

4. The polyurethane composition raw material liquid agent according to claim 1, having a viscosity at 25° C. and a rotation speed of 60 rpm of 900 mPa·s or less.

5. The polyurethane composition raw material liquid agent according to claim 4, having a viscosity at 25° C. and a rotation speed of 60 rpm of 850 mPa·s or less.

6. The polyurethane composition raw material liquid agent according to claim 1, comprising an anti-sedimentation agent.

7. The polyurethane composition raw material liquid agent according to claim 6, comprising Si as an element constituting the anti-sedimentation agent.

8. The polyurethane composition raw material liquid agent according to claim 1, wherein the filler is at least one flame retardant selected from the group consisting of a red phosphorus flame retardant, a phosphoric acid salt-containing flame retardant, a bromine-containing flame retardant, a chlorine-containing flame retardant, an antimony-containing flame retardant, a boron-containing flame retardant, and a metal hydroxide.

9. A polyurethane composition formed from a reaction product of the polyurethane composition raw material liquid agent according to claim 1.

10. The polyurethane composition according to claim 9, wherein the polyurethane composition is used as a thermal insulator for a vehicle or a building.

11. A mixing system comprising:
a first cartridge-like container filled with the polyurethane composition raw material liquid agent according to claim 1; and
a second cartridge-like container filled with another polyurethane composition raw material liquid agent that reacts with the polyurethane composition raw material liquid agent to produce a polyurethane composition, wherein
the first and second cartridge-like containers are incorporated in a caulking gun capable of mixing two components, and
the polyurethane composition raw material liquid agent extruded from the first cartridge and the another polyurethane composition raw material liquid agent extruded from the second cartridge-like container are mixed by a discharge mechanism of the caulking gun.

12. The mixing system according to claim 11, comprising a stationary mixer that mixes the polyurethane composition raw material liquid agent extruded from the first cartridge and the another polyurethane composition raw material liquid agent extruded from the second cartridge-like container.
